(19) United States
(12) Patent Application Publication
(10) Pub. No.: US 2004/0036970 A1
(43) Pub. Date: Feb. 26, 2004

(54) Projection display device

(75) Inventor: Kenji Kamei, Kodama-gun (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/607,531

(22) Filed: Jun. 27, 2003

(30) Foreign Application Priority Data
Jun. 27, 2002 (JP) 2002-188445

(51) Int. Cl. G03B 21/56

(52) U.S. Cl. 359/443

(57) ABSTRACT

A projection display device comprises a screen configured to allow light which is projected from an optical projection device to be imaged and displayed as an image, a detection section configured to detect a breakage of the screen, and a control section configured to suppress the light from being projected from the optical projection device.

### CROSS-REFERENCE TO RELATED APPLICATIONS

This application is based upon and claims the benefit of priority from the prior Japanese Patent Application No. 2002-188445, filed Jun. 27, 2002, the entire contents of which are incorporated herein by reference.

### BACKGROUND OF THE INVENTION

1. Field of the Invention

The present invention relates to an improvement in a projection display device configured to display an image by projecting light from a back surface side of a screen.

2. Description of the Related Art

In recent years, as well known in the art, there has been a growing demand that, with the spread of a home information terminal such as a personal computer, more bright and finer image be displayed on a larger screen. In response to this demand, the development of a data projector, consumer's LC (liquid crystal) television receiver, etc., has been made in a rapid pace of speed. Further, a hi-vision broadcasting has been put to practical use and there has also been a demand for their high image quality.

In the present time, in order to meet such demands and gain a larger-sized apparatus of a brighter image screen, a greater competition has been developed in the field of a projection type display device for a business use to a consumer's electrical appliance use.

As such a projection display device, there has been known a device using a liquid crystal panel. That is, such a type of device is configured to allow light which comes from a light source to be incident on a liquid crystal panel, drive the liquid crystal panel by a video signal and project exit light from the liquid crystal panel through a projection lens onto a screen. In this case, the liquid crystal panel functions as a light bulb and the incident light is modulated by the video signal to exit it. The reflection type and transmission type are generally known in the art.

In the projection display device there are two types, the first type (front projection type) being configured to display an image by allowing light which is diffusion projected from an optical projection device to be projected onto a surface side (viewer's seeing side) of a screen and the second type (back projection type) being configured to display an image by allowing light which is diffusion projected from the optical projection device to be projected onto a surface side opposite to the viewer's seeing side. As the back projection type display device there is a type as disclosed, for example, JPN PAT NO. 2569632 (U.S. Pat. No. 5,048,949).

Of these, the second type (Projection type display device) is configured to allow the light which is generated from an optical projection device to be radiated toward the viewer side and, if there occurs a breakage of a screen during a display of an image, the optical projection device is sometimes seen to the viewer. Since, in this case, a strong light beam is exited from the projection lens of the optical projection device, if a light beam focused by the projection lens enters directly into the viewer's eyes, there is a possibility that the viewer will be put in a dangerous state.

Further, as the light source, a laser light source is now being developed and, if such a laser beam has a stronger light level, there is an added danger to the viewer.

### BRIEF SUMMARY OF THE INVENTION

According to one embodiments of the present invention there is provided a projection display device comprising a screen configured to allow light which is projected from an optical projection device to be imaged onto a back surface and displayed as an image, a conduction path formed on the screen, and a detection section configured to detect a presence or absence of any broken line on the conduction path.

According to another embodiments of the present invention there is provided a projection display device comprising a screen configured to allow light which is projected from an optical projection device to be imaged onto a back surface and displayed as an image, a detection section configured to detect a breakage of the screen, and a control section configured to, when a breakage of the screen is detected by the detection section, suppress the light from being projected from the optical projection device.

### BRIEF DESCRIPTION OF THE SEVERAL VIEWS OF THE DRAWING

FIGS. 1A and 1B show one embodiment of the present invention as views for generally explaining a back surface projection display device;

FIGS. 2A to 2C are views each explaining a detail of a screen structure of the embodiment of the present invention;

FIG. 3 is a view for explaining one practical form of a conduction path in the embodiment of the present invention; and

FIG. 4 is a view for explaining another practical form of a conduction path in the embodiment of the present invention.

### DETAILED DESCRIPTION OF THE INVENTION

With reference to the accompanying drawing an explanation will be made in more detail below about one embodiment of the present invention.

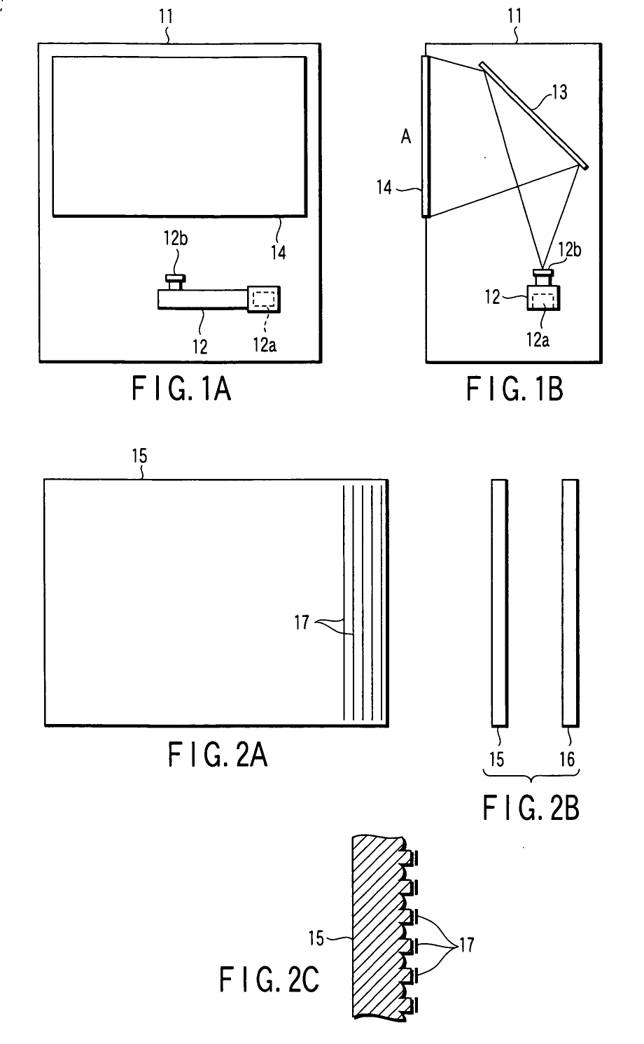

FIGS. 1A and 1B diagrammatically show a back projection type display device 11 as will be explained below in connection with the present embodiment. FIG. 1A is a front view and FIG. 1B is a side view.

The back projection type display device 11 allows light, which comes from a light source (for example, a semiconductor laser, a lamp, etc.) 12a of an optical projection device 12 to be diffusion projected through a projection lens 12b and then reflected on a reflection mirror 13 and imaged onto a back surface side of a screen 14 and, by doing so, displays a corresponding image before a viewer on an outer side A.

As shown in FIGS. 2A and 2B, this screen 14 constitutes a close contact structure of a lenticular lens 15 and Fresnel lens 16. In this case, the lenticular lens 15 is constructed on a normal surface side of the screen 14 while, on the other hand, the Fresnel lens 16 is constructed on the back surface side of the screen 14. After being emitted from the optical projection device 12, the light is reflected as diffusion light on the reflection mirror 13 and condensed onto the Fresnel lens 16 and then diffusion-imaged on the lenticular lens 15.

Here, a plurality of black stripes 17 either printed black or painted black are formed, as shown in FIG. 2C, on that surface of the lenticular lens 15 which faces the Fresnel lens 16. The black stripes 17 are normally formed as longitudinal stripes at a given interval on the whole surface of the lenticular lens 15 facing the Fresnel lens 16 as shown in FIG. 2A and have an image quality enhancing function.

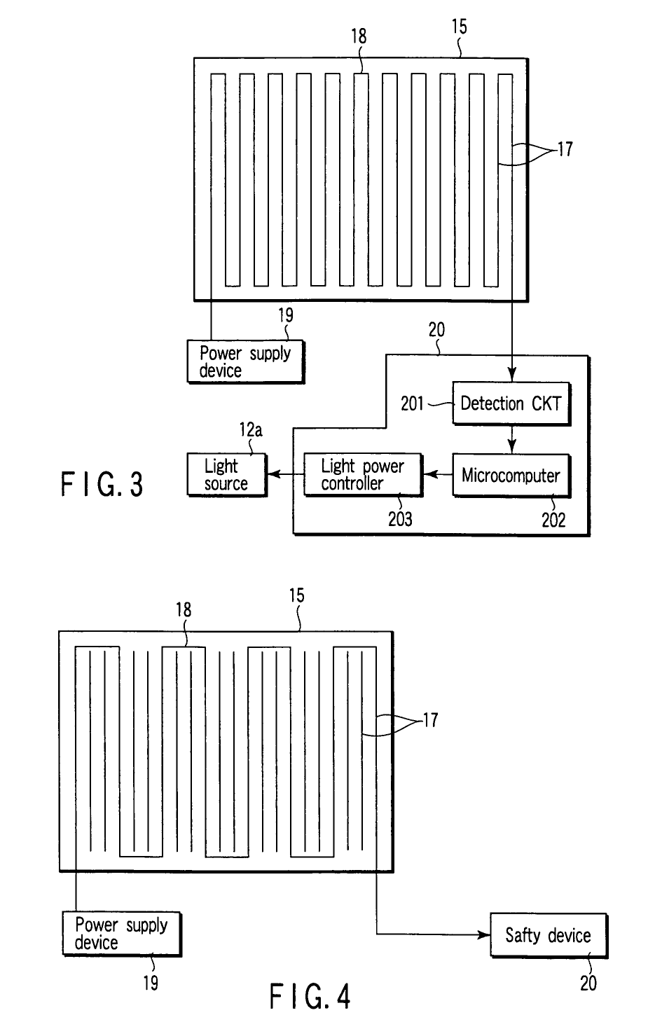

In this embodiment, the black stripes 17 are formed of a conductive black colorant and, as shown in FIG. 3, have their top/down portions connected as an alternately adjacent array to provide one series-connected conduction path 18 in a form without a hindrance to an image formation. An electric current flows from a power supply device 19 connected to one end of the conduction path 18 and is detected by a detection circuit 201 in a safety device 20 which is connected to the other end of the conduction path 18.

When the screen 14 is broken for some reason or other, the conduction path 18 is cut and the electric current from the power supply device 19 to the safety device 20 is interrupted. By doing so, the safety device 20 can detect a breakage of the screen 14. In this case, the safety device 20, for example, turns the light source 12a of the optical projection device 12 OFF, thus stopping projection of light.

The safety device 20 comprises, as shown in FIG. 3 for example, the detection circuit 201 for detecting a breakage in the conduction path 18, a microcomputer 202 for supplying a result of detection by the detection circuit 201 and a light source controller 203 for controlling turning off the light source 12a under control of the microcomputer 202.

The microcomputer 202 constitutes a control circuit and, when a breakage in the conduction path 18 is detected by the detection circuit 201, that is, when breakage of the screen 14 is detected, turns the light source 12a OFF via the light source controller 203.

According to the embodiment above, since the black stripes 17 on the screen 14 provide one conduction path 18 and a breakage of the screen 14 is detected by the ON/OFF of the electric current flowing through the conduction path 18, it is possible to positively detect a breakage of the screen 14 in the back projection type display device 11 configured to effect an image display by projecting light from the back surface side of the screen.

In the case where a breakage of the screen 14 is detected, a safety measure such as turning the light source 12a of the optical projection device 12 OFF is taken and, by doing so, the user can secure adequate safety easily.

In the case where, as a safety measure, the safety device 20 detects a breakage of the screen 14, the projection lens 12b of the optical projection device 12 is blocked and it is possible to block light from being directed toward an outside or make the light level of the light source 12a lower.

In the case where a plurality of black stripes 17 are connected together to provide one conduction path 18, it is not necessary to use all the black stripes 17. As shown, for example, in FIG. 4, even if black stripes 17 are connected together at an interval of given plural (two in FIG. 2) lines apart, as required, to provide one conduction path 18, it is possible to adequately detect a breakage of the screen 14.

Further, in order to detect any breakage on the conduction path 18, the conduction path 18 is set to, for example, a ground potential and, if the set potential varies, it is possible to detect any breakage of the line, that is, a breakage of the screen 14.

The present invention is not restricted to the above-mentioned embodiment and various changes or modifications of the invention can be made without departing from the spirit and scope of the present invention.

What is claimed is:

1. A projection display device comprising:
a screen configured to allow light which is projected from an optical projection device to be imaged on a back surface and a corresponding image to be displayed;
a conduction path formed on the screen; and
a detection section configured to detect a presence or absence of a broken line on the conduction path.

2. A projection display device according to claim 1, wherein the conduction path is formed of a conductive colorant.

3. A projection display device according to claim 1, wherein the conduction path is formed by utilizing black stripes formed on the screen.

4. A projection display device according to claim 1, wherein the connection path comprises a plurality of black stripes formed on the screen, made of a conductive colorant and connected in series.

5. A projection display device according to claim 4, wherein the connection path is formed by connecting said plurality of black stripes, each to an adjacent one, by a conductive colorant.

6. A projection display device according to claim 4, wherein the connection path is formed by connecting every n-th black stripe by a conductive colorant, where n is one or a greater integer.

7. A projection display device according to claim 1, wherein the detection section is configured to detect a presence or absence of electric current flowing through the conduction path.

8. A projection display device according to claim 1, wherein the detection section comprises a power supply circuit configured to flow electric current through the conduction path and a detection circuit configured to detect a presence or absence of the electric current flowing through the conduction path from the power supply circuit.

9. A projection display device according to claim 1, wherein the detection section is configured to detect a potential variation in the conduction path.

10. A projection display device comprising:
a screen configured to allow light which is projected from an optical projection device to be imaged on a back surface and displayed as a corresponding image;
a detection section configured to detect a breakage of the screen; and
a control section configured to, when breakage of the screen is detected by the detection section, suppress the projection of the light from the optical projection device.

11. A projection display device according to claim 10, wherein the detection section is configured to detect a presence or absence of a breakage of a conductive path on the screen.

12. A projection display device according to claim 11, wherein the control section is configured to turn a light source of the optical projection device OFF when a breakage of the conduction path is detected.

13. A projection display device according to claim 11, wherein the control section is configured to block a projection lens of the optical projection device when a breakage of the conductive path is detected.

14. A projection display device according to claim 11, wherein the control section is configured to lower a light level of the light source of the optical projection device when a breakage of the conduction path is detected.

15. A projection display device comprising:
a screen configured to allow light which is projected from an optical projection device to be imaged on a back surface and displayed as an image, the screen being formed of a combination of a lenticular lens and Fresnel lens with a plurality of conductive black stripes provided on the lenticular lens;
a conduction path created such that the conductive black stripes on the screen are electroconductively connected, at a given interval, as a series-connected array; and
a detection section configured to detect a presence or absence of breakage in the conductive path; and
a control section configured to, when a breakage in the conduction path is detected by the detection section, suppress the projection of the light from the optical projection device.
